(19) United States
(12) Patent Application Publication
(10) Pub. No.: US 2005/0007966 A1
(43) Pub. Date: Jan. 13, 2005

(54) Apparatus with multi-lane serial link and method of the same

(76) Inventor: Chi Chang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/846,764

(22) Filed: May 14, 2004

(30) Foreign Application Priority Data
Jul. 7, 2003 (TW) 092118534

(51) Int. Cl. H04J 3/06

(52) U.S. Cl. 370/282; 370/509

(57) ABSTRACT

An apparatus with multi-lane serial link and a method thereof is disclosed. The embodiment of the invention includes a common clock generator and a plurality of transceivers. The common clock generator is used for generating at least a transmit clock and a plurality of receive clocks. The transceiver serializes the transmit data and outputs a first transmit a differential signal and a second transmit a differential signal; and the transceiver also de-serializes the first receive differential signal and the second receive differential signal and outputs the receive data.

This application claims the benefit of Taiwan application Serial No. 092118534, filed Jul. 07, 2003, the subject matter of which is incorporated herein by reference.

### BACKGROUND OF THE INVENTION

1. Field of the Invention

The invention relates in general to an apparatus with serial link and a method of the same, and more particularly to an apparatus with multi-lane serial link and a method of the same.

2. Description of the Related Art

Since there is a demand for a much higher data transmission speed, prevalent parallel transmission architecture such as PCI architecture is gradually insufficient. The parallel transmission architecture uses several connection lines, of which the clocks need to be synchronous. However, it is very difficult to achieve the synchronous clocks for the connection lines at a high data transmission speed.

Conventionally, a serial transmission is used as a high-speed transmission, such as used in a universal serial bus (USB). Take a USB 2.0 standard for example: it transmits at 480 Mbits/s with a clock frequency 240 MHz. If a higher transmission rate is required, such as more than 1 GHz, a serialize/de-serialize (SERDES) transceiver is then used. The serialize/de-serialize (SERDES) transceiver can be used in PCI express architecture for instance.

FIG. 1 is a block diagram showing a conventional serialize/de-serialize (SERDES) transceiver. A serialize/de-serialize (SERDES) transceiver 100 includes a transmit unit 120 for transmitting a signal and a receive unit 140 for receiving a signal. An operation of the SERDES transceiver 100 to transmit and receive the signal is executed in a differentially driven pair from. As in FIG. 1, it shows a transmit pair TxP & TxN and a receive pair RxP & RxN.

The transmit unit 120 includes a transmit clock generator 122 and a transmitter 124. The transmit clock generator 122 generates a transmit clock tCLK and outputs to the transmitter 124. Upon receiveing the transmit clock tCLK and the input data tData, the transmitter 124 serializes the data tData and then outputs the transmit pair TxP & TxN.

Moreover, the receive unit 140 includes a receiver 142 and a clock data recovery unit (CDR) 144. Upon receiving the receive pair RxP & RxN, the receiver 142 de-serializes receive pair RxP & RxN for outputting de-serialized data to the clock data recovery unit (CDR) 144. The clock data recovery unit 144 recovers the clock and data of the de-serialized data according to a clock signal generated by a clock generator 146, using phase tracking procedure, for example.

In PCI express architecture, the host may connect to peripheral devices with multi-lane serial link for higher transceiving rate. However, the SERDES transceiver 100 of each lane as shown in FIG. 1 requires two sets of the clock generators, and more clock generators are needed for a multi-lane serial link. The clock generators occupies a large space in a chip, and also wastes power.

### SUMMARY OF THE INVENTION

It is therefore an objective of the present invention to provide an apparatus with multi-lane serial link having a common clock generator and a method of the same.

According to the objective of the present invention, an apparatus with multi-lane serial link is provided, including a common clock generator and a plurality of serialize/de-serialize (SERDES) transceivers. The common clock generator generates at least a transmit clock and a plurality of receive clocks. Every SERDES transceiver is used to serialize transmit data for outputting a transmit pair according to any one of the transmit clock, and also de-serializing a received receive pair to output receive data according to the receive clocks.

Accordingly, the present invention also provides a method of multi-lane serial link, which is controlled by a common clock generator, including steps of:

Firstly, at least a transmit clock and a plurality of receive clocks are provided. The transmit clock and the receive clocks are generated by the common clock generator. Subsequently, a transmit pair is generated by functioning the transmit clock to serialize a transmitted transmit data, and also a receive data is generated by functioning the receive clock to de-serialize a received receive pair.

A number of the above-mentioned receive clocks is a multiple of a number of the transmit clocks, so that he receive clocks perform an over-sampling technique on a bit space of the transmit pair. Further, a first enabling signal and a second enabling signal control the transmit clock and the receive clocks to work on the transmit data and the receive pair, respectively. Therefore, it can make good use of electricity and is economic.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1(Prior Art) is a block diagram showing a conventional serialize/de-serialize (SERDES) transceiver.

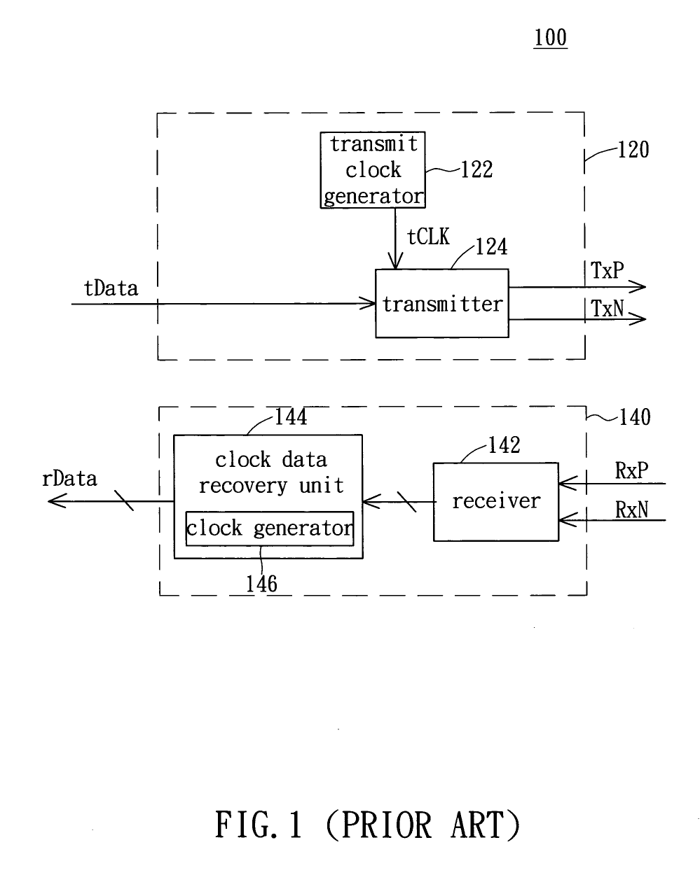

FIG. 2 is a block diagram showing an apparatus with multi-lane serial link of a preferred embodiment of the present invention.

### DETAILED DESCRIPTION OF THE INVENTION

Every serial link includes at least a lane, which is controlled by the above-mentioned SERDES transceiver. The increase in the number of the lanes can rise the receive and transmit rate of the peripheral devices.

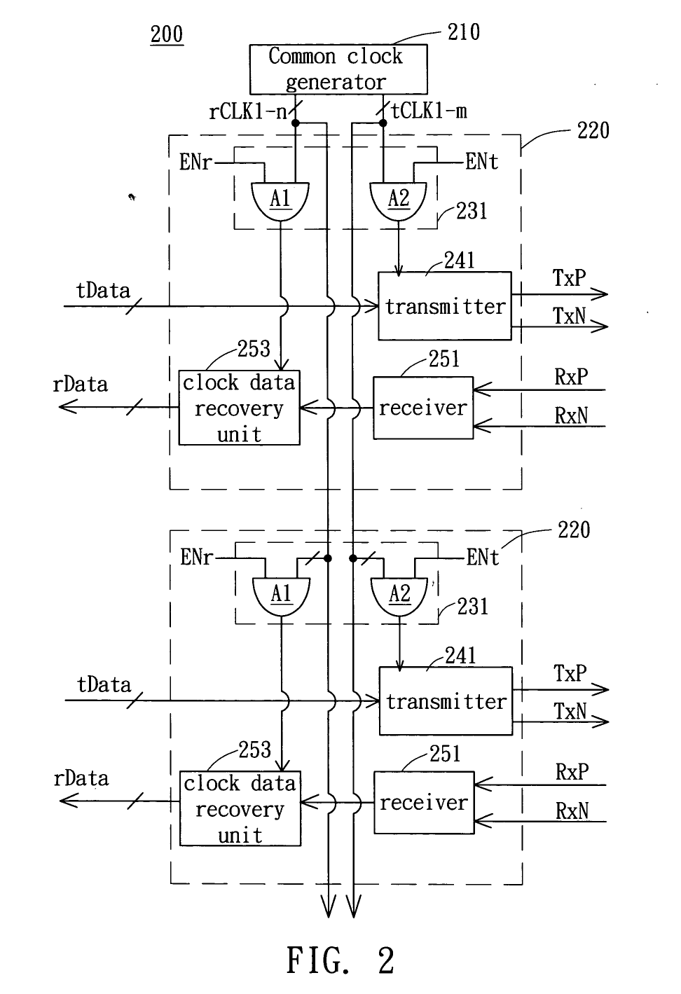

An apparatus with serial link can be designed to have several lanes to speed up its transmit rate. For example, a transmit rate of an apparatus with sixteen-lane serial link is sixteen times speedier than that with single-lane serial link. FIG. 2 is a block diagram showing an apparatus with multi-lane serial link of a preferred embodiment of the present invention. The apparatus with multi-lane serial link 200 includes a common clock generator 210 and a plurality of serialize/de-serialize (SERDES) transceivers 220. FIG. 2 takes an apparatus with two-lane serial link as an example, but the invention is not limited to only have two lanes. The common clock generator 210 generates a plurality of transmit clocks tCLK1-m and a plurality of receive clocks rCLK1-n to provide for every SERDES transceiver 220, where m and n are integers at least equal or greater than one. Every SERDES transceiver 220 serializes parallel data tData for outputting a transmit pair TxP & TxN according to the transmit clocks tCLK1-m. And also every SERDES transceiver 220 de-serializes receive pair RxP & RxN for outputting data rData according to the receive clock rCLK1-n.

Every serialize/de-serialize (SERDES) transceiver 220 includes an enabling unit 231, a transmit unit 241, a receive unit 251, and a clock data recovery unit (CDR) 253. The enabling unit 231 determines whether to output the transmit clocks tCLK1-m and the receive clocks rCLK1-n according to a transmit enabling signal ENt and a receive enabling signal ENr, respectively. Therefore, if there is no any receive or transmit action of the SERDES transceiver 220, the transmit enabling signal ENt and the receive enabling signal ENr can stop supplying a clock, so as to save power. The enabling unit 231 has, for example, a first AND gate A1 and a second AND gate A2. The first AND gate A1 determines whether to output the receive clocks rCLK1-n to the clock data recovery unit 253 according to the receive enabling signal Enr; the second AND gate A2 determines whether to output the transmit clocks tCLK1-m according to the transmit enabling signal ENt. The enabling unit 231 is used for controlling the output of the clocks, therefore, the power can be saved economically.

The transmit unit 241 outputs the transmit pair TxP & TxN after receiving transmit clocks tCLK1-m and serializing the parallel data tData. The receive unit 251 receives the receive pair RxP & RxN and transforms the receive pair RxP & RxN into parallel data, which is then outputted to the clock data recovery (CDR) unit 253. The clock data recovery unit (CDR) 253 needs not include a clock generator, for it utilizes the receive clocks rCLK1-n outputted from the common clock generator 210. The clock data recovery unit (CDR) 253 processes the parallel data in accordance with the receive clocks rCLK1-n for outputting the receive data rData. Since the clock data recovery (CDR) unit 253 does not include the clock generator, the embodiment can reduce the area of the chip effectively.

The clock data recovery (CDR) unit 253 uses an over-sampling technique, so that the receive clocks rCLK1-n with a variety of phases are needed. The over sampling technique samples a bit in a plurality of times, and then determines the content of the bit to be 1 or 0 accordingly. Since the over-sampling technique is in digital format, the embodiment can be implemented in a chip with smaller area, and also can achieve a better accuracy. In addition, the common clock generator 210 can be a multi-phase phase lock loop circuit to generate transmit clocks tCLK1-m and receive clocks rCLK1-n, which is able to generate at least 30-40 different phases of the clocks at the same time. And also the clock data recovery (CDR) unit 253 applies the over-sampling technique, therefore a multi-phases receive clock rCLK is required. For example, we can set n=3m, which represents the common generator 210 generates a transmit clock tCLK1, and also three corresponding different receive clocks rCLK1-3 are generated simultaneously, so that the clock data recovery (CDR) unit 253 can perform three times samplings on a bit.

The embodiment of the invention has advantages of:

First, the transceivers of lanes share the same common clock generator, which can simplify circuit and is easy to design, so as to reduce the area of the chip.

Second, every lane includes the enabling unit to control an output of the control clock, so as to save electricity.

Third, the clock data recovery (CDR) unit is achieved by using a digital technology; thereby not only electricity can be saved but also the used area of the chip can be reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. An apparatus with multi-lane serial link comprising:
a common clock generator, which generates at least a transmit clock and a plurality of receive clocks; and
a plurality of serialize/de-serialize (SERDES) transceivers, wherein every SERDES transceiver is used for serializing transmit data and outputting a transmit pair according to the transmit clock, and also de-serializing a receive pair to output receive data according to the receive clocks.

2. The apparatus with multi-lane serial link according to claim 1, wherein the serialize/de-serialize (SERDES) transceivers comprises:
an enabling unit, which determines whether to output the transmit clock and the receive clocks according to a transmit enabling signal and a receive enabling signal, respectively;
a transmit unit, which outputs the transmit pair after serializing the transmit data according to the transmit clock outputted by the enabling unit; and
a receive unit, which outputs the receive data according to the received receive pair and the receive clocks.

3. The apparatus with multi-lane serial link according to claim 2, wherein the enabling unit comprises:
a first AND gate, which determines whether to output the receive clocks according to the receive enabling signal.

4. The apparatus with multi-lane serial link according to claim 2, wherein the enabling unit comprises:
a second AND gate, which determines whether to output the transmit clock according to the transmit enabling signal.

5. The apparatus with multi-lane serial link according to claim 2, wherein the receive unit comprises:
a receive unit for receiving and de-serializing the receive pair to output parallel data;
a clock data recovery (CDR) unit for outputting the receive data according to the parallel data and the receive clocks outputted by the enabling unit.

6. The apparatus with multi-lane serial link according to claim 5, wherein the clock data recovery (CDR) unit applies an over-sampling technique.

7. The apparatus with multi-lane serial link according to claim 1, wherein the common clock generator is a multi-phase phase lock loop circuit.

8. A method of multi-lane serial link, which is controlled by a common clock generator, comprising steps of:
providing at least a transmit clock and a plurality of receive clocks, wherein the transmit clock and the receive clocks are generated by the common clock generator; and
generating a transmit pair by serializing a transmitted transmit data according to the transmit clock, and also generating receive data by de-serializing a received receive pair.

9. The method of multi-lanes serial link according to claim 8, wherein the number of the receive clocks is a multiple of the number of the transmit clock.

10. The method of multi-lanes serial link according to claim 9, wherein an over-sampling technique is performed using the receive clocks on a bit.

11. The method of multi-lanes serial link according to claim 8, wherein a first enabling signal and a second enabling signal control the transmit clock and the receive clocks, respectively.
